(19) United States
(12) Patent Application Publication
(10) Pub. No.: US 2020/0189433 A1
(43) Pub. Date: Jun. 18, 2020

(54) ARM REST FOR A VEHICLE

(71) Applicant: Barry Alan Sloan, Melbourne, FL (US)

(72) Inventor: Barry Alan Sloan, Melbourne, FL (US)

(21) Appl. No.: 16/456,701

(22) Filed: Jun. 28, 2019

Related U.S. Application Data
(60) Provisional application No. 62/780,539, filed on Dec. 17, 2018.

(51) Int. Cl. B60N 2/75

(52) U.S. Cl. CPC B60N 2/783

(57) ABSTRACT

An arm rest includes a hook formed of a first vertical member, a horizontal member joined to the first vertical member by a first bend in a first direction, and a second vertical member joined to the horizontal member by a second bend in the first direction. A horizontal arm rest member is joined to the second vertical member by a third bend in a second direction opposite the first direction.

### CROSS-REFERENCE TO RELATED APPLICATION

This application claims the benefit of priority of U.S. provisional application No. 62/780,539, filed Dec. 17, 2018, the contents of which are herein incorporated by reference.

### BACKGROUND OF THE INVENTION

The present invention relates to an arm rest and, more particularly, to an arm rest for supporting a left arm of a driver while driving a vehicle.

Driving either short or long distances can put a strain on a driver's left arm, shoulder and elbow. Currently, there is no comfortable place to rest the left arm while driving. The interior door panel is too high or too far away from the driver. The interior door handle/arm rest, provided by the car manufacture, is too low to provide the proper support for the left arm.

As can be seen, there is a need for an arm rest for supporting a left arm of a driver while driving a vehicle.

### SUMMARY OF THE INVENTION

In one aspect of the present invention, a method of providing support for a user's arm in a vehicle comprises steps of: providing an arm rest comprising: a hook comprising a first vertical member, a horizontal member joined to the first vertical member by a first bend in a first direction, a second vertical member joined to the horizontal member by a second bend in the first direction; and a horizontal arm rest member joined to the second vertical member by a third bend in a second direction opposite the first direction; and inserting the first vertical member within a window slot of a door of a vehicle so that an upper portion of an interior door panel is disposed in between the first vertical member, the horizontal member, and the second vertical member.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a side view of an embodiment of the present invention shown in use;

FIG. 4 is a section view of the present invention, taken along line 4-4 in FIG. 1; and

FIG. 5 is a detail section view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a left arm rest that places a user's arm, hand, and shoulder at the optimal driving position. The present invention elevates a user's elbow and forearm to the proper height to reach the steering wheel in the correct “10-2” position for comfort and control.

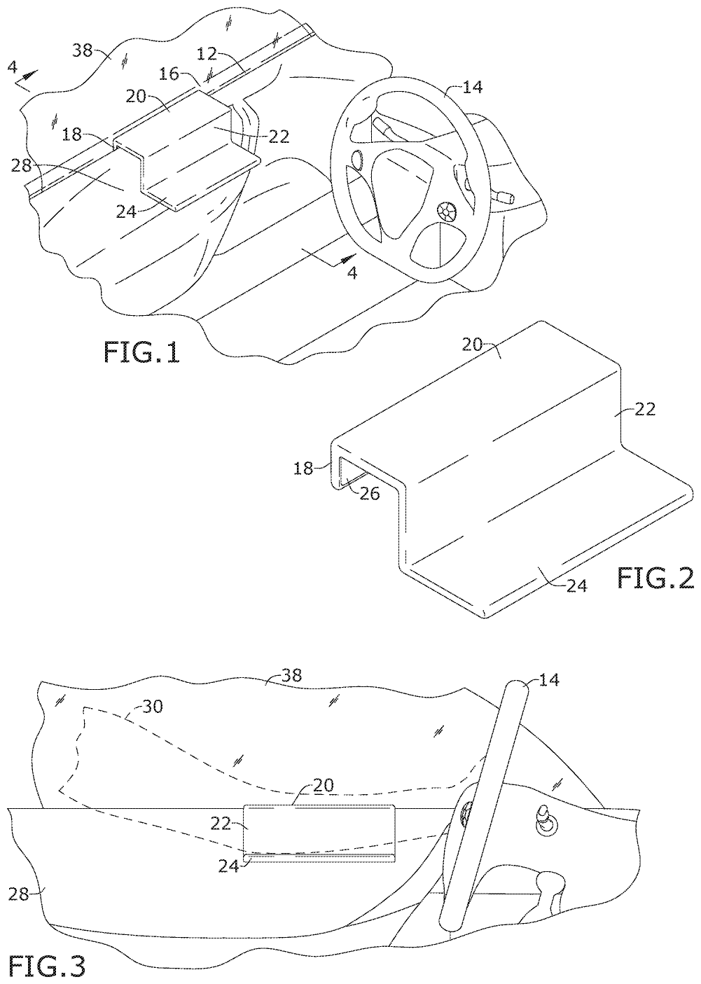

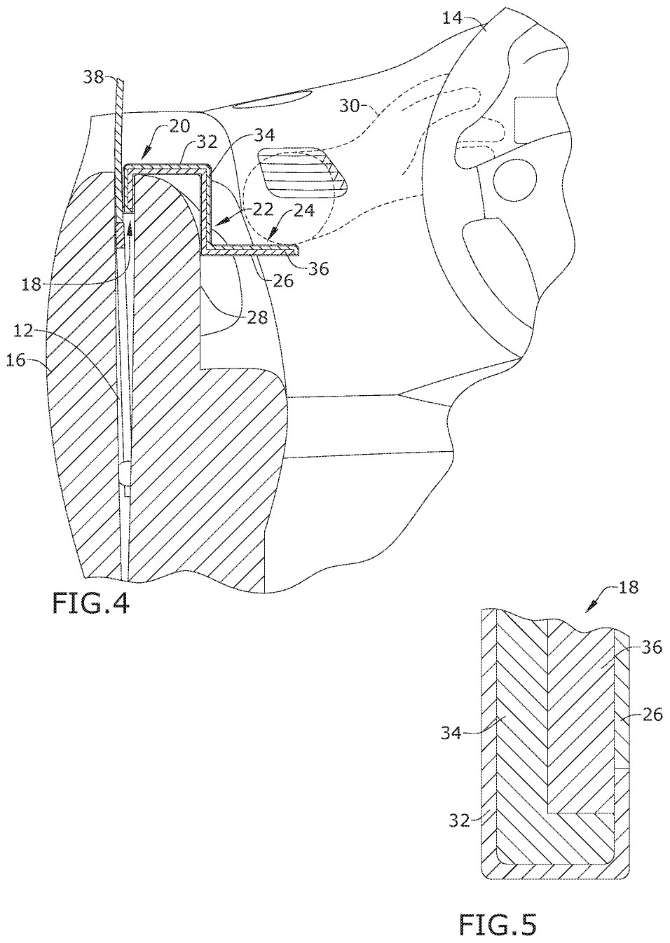

Referring to FIGS. 1 through 5, the present invention includes an arm rest 10. The arm rest 10 includes a hook formed of a first vertical member 18, a horizontal member 20 joined to the first vertical member 18 by a first bend in a first direction, and a second vertical member 22 joined to the horizontal member 20 by a second bend in the first direction. A horizontal arm rest member 24 is joined to the second vertical member 22 by a third bend in a second direction opposite the first direction.

The arm rest 10 may include a frame 36 made of a metal or rigid plastic material. The arm rest 10 further includes a foam padding 34 adhered to the frame 36 and disposed on an upper surface of the horizontal arm rest member 24, the first vertical member 18, the horizontal member 20, and the second vertical member 22. The foam padding 34 may be added for comfort. A covering 32 may cover an upper surface of the entire arm rest 10. The covering 26 may be made of elements found in most cars, such as vinyl or leather. In certain endpoints, a protective layer 26, such as felt material, may be added to the underside that protects the interior car surface.

The present invention further includes a method of providing support for a user's arm 30 in a vehicle. Provide the arm rest 10 disclosed above. Insert the first vertical member 18 between the glass and the door member within a window slot 12 of a door 16 of a vehicle so that an upper portion of an interior door panel 28 is disposed in between the first vertical member 18, the horizontal member 20, and the second vertical member 22. The user may then rest their arm 30 on the horizontal arm rest member 34, which supports the user's arm 30 in a position to hold the steering wheel 14 of the vehicle.

An exemplary method of making the present invention may include the following. Cut and bend a blank piece of aluminum to the length and width required to make the frame 36. Apply the neoprene foam 34 underlayment to the metal using contact cement. Apply the polyester felt lining to the back surface with adhesive. Cover the arm rest 10 with a vinyl or leather covering 26 for a finished look.

It should be understood, of course, that the foregoing relates to exemplary embodiments of the invention and that modifications may be made without departing from the spirit and scope of the invention as set forth in the following claims.

What is claimed is:

1. A method of providing support for a user's arm in a vehicle comprising steps of:
providing an arm rest comprising:
a hook comprising a first vertical member, a horizontal member joined to the first vertical member by a first bend in a first direction, a second vertical member joined to the horizontal member by a second bend in the first direction; and
a horizontal arm rest member joined to the second vertical member by a third bend in a second direction opposite the first direction; and
inserting the first vertical member within a window slot of a door of a vehicle so that an upper portion of an interior door panel is disposed in between the first vertical member, the horizontal member, and the second vertical member.

2. The method of claim 1, wherein the arm rest comprises a frame made of a metal or rigid plastic material.

3. The method of claim 2, wherein the arm rest further comprises a foam padding adhered to the frame and disposed on an upper surface of the horizontal arm rest member.

4. The method of claim 3, wherein the foam padding is further disposed on an upper surface of the first vertical member, the horizontal member, and the second vertical member.

5. The method of claim 4, further comprising a covering disposed over the hook and the horizontal arm rest.

6. The method of claim 5, wherein the covering is made of at least one of leather and vinyl.
